(19) United States
(12) Patent Application Publication
(10) Pub. No.: US 2008/0197695 A1
(43) Pub. Date: Aug. 21, 2008

(54) Wheels having superior shock absorption and transport devices usint the same

(76) Inventor: Kyosuke Uemura, Tokyo (JP)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(21) Appl. No.: 12/070,269

(22) Filed: Feb. 15, 2008

Related U.S. Application Data
(60) Provisional application No. 60/902,231, filed on Feb. 20, 2007.

(51) Int. Cl. B60B 1/06; B60B 5/02

(52) U.S. Cl. 301/64.703; 301/64.704; 301/5.301

(57) ABSTRACT

A wheel having a hub, a rim, at least two ring-shaped spokes connecting the hub and the rim, and a tire arranged around the outer periphery of the rim; wherein each of the ring-shaped spokes is formed from an elastic material, connected with the hub at the inner periphery, connected to the rim at the outer periphery, and is attached in a state of being stretched beyond dimensions when not subjected to stress.

This application claims the benefit of U.S. Provisional Application No. 60/902,231, filed Feb. 20, 2007, which is incorporated herein by reference in its entirety.

### BACKGROUND OF THE INVENTION

1. Field of the Invention

The present invention relates to a wheel having superior shock absorption. More particularly, the present invention relates to a wheel containing spokes having superior shock absorption. In addition, the present invention relates to a transport device such as a suitcase, carrier cart, push cart, shopping cart or wheelchair.

2. Description of the Related Art

Transport devices such as suitcases, carrier carts, push carts, shopping carts or wheelchairs normally employ 2 to 4 wheels. Nearly all of the wheels employed in conventional transport devices lack shock absorption. Thus, forces resulting from contact or impact of a wheel with a road or floor surface are conveyed directly to the body of the transport device, thereby resulting in the risk of damage to precision machinery or other transported articles susceptible to damage. In addition, the running of a wheel on a floor surface can generate noise.

In consideration of this point, it can be desirable that the above-mentioned transport device have superior shock absorption as well as superior running quietness. A shock absorbing apparatus is normally arranged between the body of the transport device and the wheels for the purpose of imparting shock absorption to the transport device. Shock absorbing apparatuses include coil springs, cushioning rubber and other elastic bodies. However, providing a shock absorbing apparatus can increase the weight and production cost of the transport device. In some transport devices there may be insufficient room for providing a shock absorbing apparatus, particularly in transport devices using small diameter wheels.

In Japanese Patent Application Laid-open No. 2006-103394, a wheel was described having a stretching portion, and a plurality of stretching control portions for controlling stretching of the stretching portion as means for improving shock absorption and running quietness of a wheel.

### SUMMARY OF THE INVENTION

In one aspect, the present invention is a wheel having a hub, a rim, at least two ring-shaped spokes connecting the hub and the rim, and a tire arranged around the outer periphery of the rim; wherein each of the ring-shaped spokes is formed from an elastic material, connected with the hub at the inner periphery, connected to the rim at the outer periphery and, when attached, said spokes are stretched beyond the normal dimensions.

It is an object of the present invention to provide a wheel having a simple structure and superior shock absorption without increasing the weight or production cost thereof. In addition, it is an object of the present invention to provide a wheel having superior shock absorption applicable to transport devices having small diameter wheels where there is no room for a shock absorbing apparatus. Moreover, it is an object of the present invention to provide a wheel having improved running quietness.

In another aspect, the present invention is a transport device comprising a wheel as described herein. The transport device of the present invention may be a suitcase, carry cart, push cart, shopping cart or wheelchair, for example. Other uses may be discerned by one of ordinary skill in the art, without departing from the intended scope of the invention—that is, to provide a transport device providing shock absorption and quiet running without use of a separate shock absorption apparatus.

### BRIEF DESCRIPTION OF THE DRAWINGS

FIGS. 1A and 1B are drawings for explaining an embodiment of a wheel of the present invention, with FIG. 1A being a cross-sectional view and FIG. 1B being a view as seen from the direction of arrow (1b);

FIG. 2 is a drawing for explaining another embodiment of a wheel of the present invention; and,

FIG. 3 is a drawing for explaining another embodiment of a wheel of the present invention.

### DETAILED DESCRIPTION OF THE INVENTION

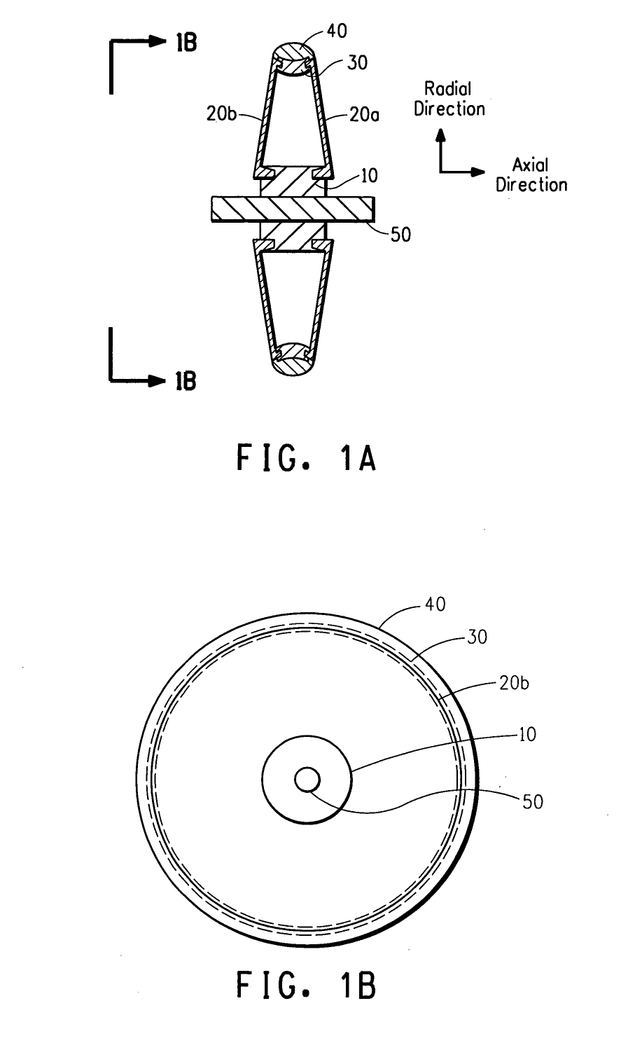

FIG. 1 shows a wheel of a first embodiment of the present invention. FIG. 1A is a cross-sectional view of a wheel of the present invention, while FIG. 1B is another cross-sectional view of a wheel of the present invention, cut down the center of the radial plane of the wheel and viewed from the direction of arrow (1b) (in FIG. 1a). The wheel of the present invention has a hub (10), a rim (30), at least two ring-shaped (doughnut-shaped) spokes (20) connecting the hub (10) and the rim (30), and a tire (40) arranged around the outer periphery of the rim (30). Here, each of the ring-shaped spokes (20) is formed from an elastic material, is connected with the hub (10) at the inner periphery, is connected with the rim (30) at the outer periphery, is attached in a state of being stretched beyond the dimensions when not subjected to stress.

The hub (10) is a roughly cylindrical component arranged at the center of the wheel, has means for fastening one end of the ring-shaped spokes (20), and has a hole for inserting an axle (50) through the center thereof. The hole for inserting the axle (50) may be a through hole or a non-through hole. FIG. 1 shows an example in which the hole for inserting the axle (50) is in the form of a through hole, and a spoke fastening unit for fastening the ring-shaped spokes (20) is provided on both sides of the hub (bottom of the cylinder). The hub (10) can be produced using a resin such as polyester, polypropylene, polyacetal or polyamide (such as Nylon), or any engineering material that is known and conventional. The resin used to form the hub (10) may contain a reinforcing material such as glass fibers or organic fibers to improve the mechanical strength of the hub (10). Examples of organic fibers that can be used include carbon fibers, aramid fibers (such as Kevlar®, commercially available from DuPont) and polyparaphenylene benzobisoxazole fibers (such as Zylon®, commercially available from DuPont). Since the above-mentioned resins have superior creep resistance, hubs (10) formed from these resins are able to maintain strength over a long period of time with respect to a continuous load from the spokes held in a stretched state.

The hub (10) may make direct contact with the axle (50), or contact may be made with the axle (50) via a bearing (not shown) arranged within the through hole for holding the axle (50) present in the center of the hub (10). The bearing may be any type of bearing known in the art, including rolling bearings such as a ball bearing or roll bearing, and sliding bearings such as a sleeve bearing. The bearing is preferably made of a resin. As a result of the bearing being made of resin, simultaneous to being able to avoid the occurrence of rusting and leakage of lubricants, reduction of the wheel weight can also be realized. The bearing can preferably be produced using a polyimide resin and the like. Since polyimide resin has superior sliding properties when subjected to a large load, the diameter of the axle (50) can be reduced and frictional resistance during rotation can be decreased.

The rim (30) is a member located around the outer periphery of the wheel for fastening one end of the ring-shaped spokes (20). FIG. 1 shows an example of the rim (30) supporting the tire (40) on the outer peripheral surface thereof, and having a spoke fastening portion for fastening the ring-shaped spokes (20) on both sides thereof. The rim (30) has adequate strength for maintaining the ring-shaped spokes (20) in a stretched state. The rim (30) can be produced using a resin such as polyester, polypropylene, polyacetal or polyamide (such as Nylon). The resin for forming the rim (30) may contain a reinforcing material such as glass fibers or organic fibers for improving the mechanical strength of the rim (30). Examples of organic fibers that can be used include carbon fibers, aramid fibers (such as Kevlar®) and polyparaphenylene benzobisoxazole fibers (such as Zylon®). Since the above-mentioned resins have superior creep resistance, the rim (30) formed from these resins is able to maintain strength over a long period of time with respect to a continuous load from the spokes held in a stretched state.

In the case of using a wheel of the present invention as a steering wheel, a torsional moment is generated in the direction perpendicular to the axial direction (direction from the ground towards the center of the wheel) at the location where the wheel contacts the ground. By steering wheel, it is meant a wheel that assists in guiding the transport device. It is preferable to improve the rigidity of the wheel in the axial direction to prevent deformation of the wheel caused by this torsional moment. A plurality of linking members (not shown) that link the hub (10) and the rim (30) may be arranged to improve the rigidity of the wheel in the axial direction. These linking members preferably have a variable cross-section that is easily deformed in the radial direction of the wheel, but not easily deformed in the axial direction. As a result, it is possible to improve both shock absorption brought about by the ring-shaped spokes (20) and rigidity of the wheel in the axial direction. A plurality of linking members are preferably symmetrically arranged at locations such that the axle (50) serves as a rotationally symmetrical axle of two rotations or more.

The tire (40) is a member that is located around the outermost periphery of the wheel, arranged on the outer peripheral surface of the rim (30), and makes contact with the ground. The tire (40) may have a single-layer structure as shown in FIG. 1, or it may have a laminated structure consisting of a plurality of layers (by, for example, combining an inner tire that contacts the rim (30) and an outer tire that contacts the ground). The tire (40) can be produced using a material such as a polyester elastomer, resin such as polyurethane or rubber depending on the application. In addition, the tire (40) may have a tread pattern in the surface that makes contact with the ground. Suitable tires are known and may be conventional in the art of wheel manufacture.

The ring-shaped spokes (20) serve as members that provide shock absorption by connecting the hub (10) and the rim (30). The ring-shaped spokes (20) are formed with an elastic materials and preferably an elastic material having an expansion ratio of 5 to 20%, compared with the normal (unstretched) dimensions, when subjected to stress of 6 to 60 MPa. Having an expansion ratio of 5 to 20% when subjected to stress of 6 to 60 MPa refers to intersection or contact with an area (including the boundary) defined by four lines of X=6 MPa, X=60 MPa, Y=5% and Y=20% when having drawn a stress vs. expansion ratio curve for the ring-shaped spokes by plotting stress on the X axis and elongation ratio on the Y axis. The preferable expansion ratio differs according to the strength required of the spokes and the spoke size. In the case of small wheels and a comparatively large load in the manner of a suitcase, a material can be used so as to demonstrate, for example, an expansion ratio of 5 to 20% when subjected to stress of 60 MPa. However, suitcase wheels are not limited to this range.

Examples of elastic materials that can be used include polyester elastomers, polyolefin elastomers, polyamide (Nylon) elastomers and polyurethane. Woven fabrics composed of fibers of these materials or films of these materials can be used as materials for forming the ring-shaped spokes (20). The woven fabric or film can be processed by blanking processing and so on to obtain ring-shaped spokes (20) having a desired shape and dimensions.

FIG. 1 shows an example of the case of using two ring-shaped spokes (20) consisting of an outer spoke (20a). connecting one side (e.g., the outside) of the hub (10) and the rim (30) in the axial direction, and an inner spoke (20b) connecting the outer side (e.g., the inside) of the hub (10) and the rim (30) in the axial direction. However, the hub (10) and the rim (30) be also connected with the ring-shaped spokes (20) at other sites (such as the outer peripheral surface of the hub (10) or the inner peripheral surface of the rim (30)). Alternatively, the hub (10) and the rim (30) may also be connected using three or more ring-shaped spokes (20).

The ring-shaped spokes (20) connect the hub (10) and the rim (30) in the state of being stretched beyond the dimensions when not subjected to stress, and preferably in the state of having an expansion ratio of 5 to 10%. The term “expansion ratio” in the present invention refers the value obtained by dividing the difference in dimensions between the stretched state and the state in the absence of stress by the dimension in the absence of stress. Differing from a so-called “disc wheel” in which the hub and rim are connected with a rigid disc, the wheel of the present invention is able to absorb shocks applied from the ground to the wheel and realize superior running quietness due to expansion and contraction of the elastic material that composes the ring-shaped spokes 20. Although dependent on the load to be supported by the wheel and the shock to be absorbed of the target application, by making the degree of elasticity of the elastic material that forms the ring-shaped spokes (20) (defined with the expansion ratio when subjected to stress of 6 to 60 MPa in the present invention) and the expansion ratio of the ring-shaped spokes (20) when attached to be within the above-mentioned range, adequate shock absorption and quite running can be imparted to the wheel.

Differing from wire spokes typically used in bicycles and the like, since the ring-shaped spokes (20) of the present invention do not have openings, they have a reduced risk of fingers and so on being accidentally pinched thereby, and have improved safety. In addition, as a result of the ring-shaped spokes (20) of the present invention not having openings, the sides of the wheel are roughly flat, thereby improving ease of cleaning the wheel as compared with the case of using wire spokes having a complex shape. Alternatively, one or a plurality of openings can be provided in the ring-shaped spokes (20) of the present invention when desired to provide a wheel having superior design and lighter weight.

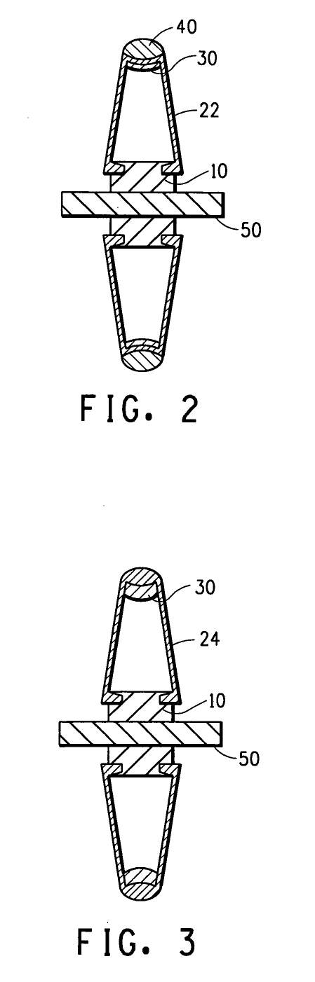

Another aspect of a wheel of the present invention is shown in FIG. 2. In the aspect of FIG. 2, end-connected spokes (22), in which the ends thereof on the side of the rim (30) are connected, are used for the two ring-shaped spokes. The connected portion of these end-connected spokes (22) is located on the outer peripheral surface of the rim (30), and the tire (40) is attached to the outer peripheral surface of said connected portion. These end-connected spokes (22) can be formed by, for example, injection molding, from an elastic material having an expansion ratio of 5 to 20% when subjected to stress of 6 to 60 MPa, examples of which include polyester elastomers, polyolefin elastomers, polyamide (Nylon) elastomers and polyurethane. In addition, in the present aspect, the end-connected spokes (22) are fastened to the hub (10) in a stretched state in which the dimension of a portion from the end of the connected portion of the end-connected spokes (22) to the hub (10) (namely the portion that composes the side of the wheel) is greater than the dimension of said portion when not subjected to stress, and preferably in a state of having an expansion ratio of 5 to 10%.

Another aspect of a wheel of the present invention is shown in FIG. 3. In FIG. 3, tire-integrated spokes (24), which are integrated with the tire (40), are used for the two ring-shaped spokes. These tire-integrated spokes (24) can be formed by, for example, blow molding, from an elastic material having an expansion ratio of 5 to 20% when subjected to stress of 6 to 60 MPa, examples of which include polyester elastomers, polyolefin elastomers, polyamide (Nylon) elastomers, and polyurethane. In addition, in the present aspect, the tire-integrated spokes (24) are fastened to the hub (10) in a stretched state in which the dimension of a portion from the end of the tire portion of the tire-integrated spokes (24) to the hub (10) (namely the portion that composes the side of the wheel) is greater than the dimension of said portion when not subjected to stress, and preferably in a state of having an expansion ratio of 5 to 10%.

In addition, the rim (30) in the aspect using end-connected spokes (22) or tire-integrated spokes (24) can be composed with a ring-shaped member having a cutout portion by bending a profile extruded member. In this case, one end of the rim (30) serving as the cutout can be inserted through the hole in the center of the spokes and arranged at a prescribed location inside the spokes.

A wheel of the present invention can be affixed to a transport device. A wheel of the present invention may be affixed to a transport device is selected from the group consisting of a suitcase, carry cart, push cart, shopping cart, and wheelchair. This embodiment of the present invention is provided when at least one wheel, and preferably a plurality of the wheels (more preferably 2 to 4 wheels) are affixed to a body that composes the carrier portion of the transport device. A transport of the present invention can be used in many applications and for many purposes, such as transporting goods or people. Practical applications may be limited depending upon the weight capacity of wheels and the design of the transport device. The body that composes the carrier portion of the transport device can be produced using any materials and methods known in the art. In the case of attaching four wheels (such as in the case of a push cart or wheelchair), two sets of wheels having respectively different diameters may be used. Since the wheels themselves have a shock absorbing function, a transport device of the present invention is able to run comfortably and smoothly, while also being able to realize superior running quietness. In addition, compared with conventional devices having shock absorbing means separate from the wheels, a transport device of the present invention is lighter weight and can provide superior running performance. This is because the total weight of the wheel is less due to the use of resin materials for all constituent components, and unsprung mass consists only of the rim and tire located around the outer periphery of the spokes.

### EXAMPLES

### Example 1

Each outer peripheral edge of two ring-shaped spokes comprised of a mesh material of a polyester elastomer (having an expansion ratio of 5% when subjected to stress of 6 MPa) was fastened to each side of a rim made of glass-reinforced polyester resin and having a diameter of 60 cm (about 20 inches). Each inner peripheral edge of the two ring-shaped spokes was fastened to a hub made of glass-reinforced polyester resin. The hub had a through hole in the central portion thereof for insertion of an axle, and a radial bearing made of polyimide resin was press fit inside said through hole. Each of the two ring-shaped spokes was stretched by 5% beyond the dimensions when not subjected to stress. A wheel was obtained by fastening a polyester elastomer tire to the outer peripheral surface of the rim. Wheels of the present example can be used as the main wheels of a wheelchair.

### Example 2

Each outer peripheral edge of two ring-shaped spokes comprised of a pliant sheet material (equivalent to a polyester elastomer having an elastic modulus of 30 MPa, and having an expansion ratio of 10% when subjected to stress of 30 MPa) was fastened to each side of a rim made of a glass-reinforced Nylon material and having a diameter of 10 cm. Each inner peripheral edge of the two ring-shaped spokes was fastened to a hub made of a glass-reinforced Nylon material having a through hole in the central portion thereof for insertion of an axle. Each of the two ring-shaped spokes was stretched by 10% beyond the dimensions when not subjected to stress. A wheel was obtained by fastening a polyester elastomer tire to the outer peripheral surface of the rim. Wheels of the present example can be used in a suitcase, carry cart or push cart and the like.

What is claimed is:

1. A wheel having a hub, a rim, at least two ring-shaped spokes connecting the hub and the rim, and a tire arranged around the outer periphery of the rim; wherein each of the ring-shaped spokes is formed from an elastic material, connected with the hub at the inner periphery, connected to the rim at the outer periphery and, when attached, said spokes are stretched beyond the normal dimensions.

2. The wheel according to claim 1, wherein the elastic material has an expansion ratio of 5 to 20% when subjected to stress of 6 to 60 MPa, and the attached ring-shaped spokes are stretched to provide an expansion ratio of 5 to 10%.

3. The wheel according to claim 1, wherein the elastic material is selected from the group consisting of polyester elastomers, polyolefin elastomers, polyamide elastomers and polyurethane.

4. The wheel according to claim 1, wherein the hub is formed from a resin selected from the group consisting of polyester, polypropylene, polyacetal and polyamide.

5. The wheel according to claim 4, wherein the resin is reinforced with glass fibers or organic fibers.

6. The wheel according to claim 1, wherein the rim is formed from a resin selected from the group consisting of polyester, polypropylene, polyacetal and polyamide.

7. The wheel according to claim 6, wherein the resin is reinforced with glass fibers or organic fibers.

8. The wheel according to claim 1, wherein the hub has a through hole in the center thereof for insertion of an axle, and further has a resin bearing at a contact surface between the through hole and the axle.

9. The wheel according to claim 1 wherein said wheel is affixed to a transport device.

10. The wheel according to claim 10 wherein said transport device is selected from the group consisting of a suitcase, carry cart, push cart, a shopping cart, and a wheelchair.
